(19) United States
(12) Patent Application Publication
(10) Pub. No.: US 2016/0253827 A1
(43) Pub. Date: Sep. 1, 2016

(54) METHOD FOR DETERMINING THE DANGER ZONE BETWEEN A TEST OBJECT AND AN X-RAY INSPECTION SYSTEM

(71) Applicant: YXLON INTERNATIONAL GMBH, Hamburg (DE)

(72) Inventors: Piotr KOLESNIKOFF, Hamburg (DE); Bärbel KRATZ, Luebeck (DE); Frank HEROLD, Ahrensburg (DE)

(21) Appl. No.: 15/030,598

(22) PCT Filed: Oct. 21, 2014
(86) PCT No.: PCT/EP2014/002840

§ 371 Date: Apr. 20, 2016

(30) Foreign Application Priority Data
Oct. 21, 2013 (DE) 10 2013 017 459.7

(51) Int. Cl. G06T 11/00; G06T 7/60

(52) U.S. Cl. CPC G06T 11/005; G06T 7/602; G06T 2207/10081

(57) ABSTRACT

Methods for determining a hazard area between a test object and an X-ray inspection system include arranging a radiation detector at a predetermined distance from a radiation source. Marginal rays are determined which, at a predetermined angle of rotation between the test object and the arranged radiation source and radiation detector, touch an outer contour of the test object at the predetermined angle of rotation. A hazard radius is determined from the outer contour to the rotational axis of the test object for the predetermined angle of rotation. The determination of the marginal rays is repeated for predetermined angles of rotation which are distributed over 360° and the determination of the hazard radius is repeated for each respective repeated determination of marginal rays. A table is compiled with parameters of the hazard radius obtained for each of the predetermined angles of rotation of the edge of the test object.

### CROSS-REFERENCE TO RELATED APPLICATIONS

This application is a U.S. National Phase application under 35 U.S.C. §371 of International Application No. PCT/EP2014/002840, filed on Oct. 21, 2014, and claims benefit to German Patent Application No. DE 10 2013 017 459.7, filed on Oct. 21, 2013. The International application was published in German on Apr. 31, 2015 as WO 2015/058854 under PCT Article 21(2).

### FIELD

The invention relates to a method for determining the hazard area between a test object and an X-ray inspection system rotating in opposite directions about a rotational axis running through the test object.

### BACKGROUND

Computed tomography (CT) represents an imaging modality with which the inside of objects can be represented non-destructively on the basis of X-radiation. In particular for non-destructive testing technology, CT systems with as many degrees of freedom as possible are of interest for a scan. In the case of movable device parts, such as X-ray detector, X-ray tube as well as object plates, the prevention of a collision of all the items inside the compact system is of the highest priority. In addition to a fixed limitation of the accessible space as collision protection, further procedures also exist. To date, amongst other things, there has been the possibility of monitoring a visual navigation by viewing contact (for example through an integrated lead glass window) which is, however, significantly limited by the corresponding viewing angle.

Alternatively, or additionally, pressure sensors can be used. In the case of a contact, i.e. if a collision has already taken place, the method of the object is interrupted. This type of collision prevention is to be regarded as a possibility of last resort when other measures fail. It is thereby possible to prevent major damage to the object, or to other items within the compact system. However, minor damage due to the collision cannot be ruled out.

### SUMMARY

Methods are disclosed for determining a hazard area between a test object and an X-ray inspection system include arranging a radiation detector at a predetermined distance from a radiation source. Marginal rays are determined which, at a predetermined angle of rotation between the test object and the arranged radiation source and radiation detector, touch an outer contour of the test object at the predetermined angle of rotation. A hazard radius is determined from the outer contour to the rotational axis of the test object for the predetermined angle of rotation. The determination of the marginal rays is repeated for predetermined angles of rotation which are distributed over 360° and the determination of the hazard radius is repeated for each respective repeated determination of marginal rays. A table is compiled with parameters of the hazard radius obtained for each of the predetermined angles of rotation of the edge of the test object.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a shadow image of a test object.

FIG. 2 is the background of FIG. 1 without the test object.

FIG. 3 is the difference image of FIGS. 1 and 2.

FIG. 4 is the binarization of FIG. 3.

FIG. 5 is a schematic structure for carrying out a method according to the invention.

FIG. 6 is a diagram illustrating the geometric relationships relevant to the calculation.

FIG. 7 is a result after carrying out a refined embodiment according to the invention.

FIG. 8 is a diagram illustrating the conditions in the case of a refined embodiment according to the invention.

FIG. 9 is a diagram illustrating the relevant geometric relationships in the case of a refined method according to the invention.

FIG. 10 is a representation in the case of an FDK reconstruction.

FIG. 11 is a representation of weighted pixels in the case of only one marginal ray.

FIG. 12 is a representation of weighted pixels in the case of several marginal rays.

### DETAILED DESCRIPTION

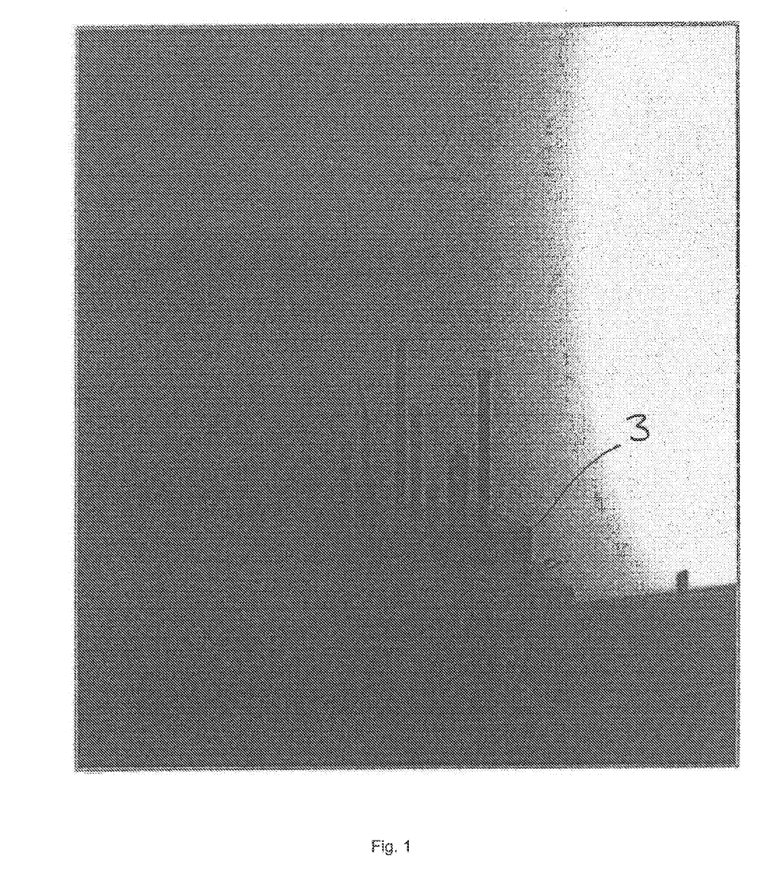

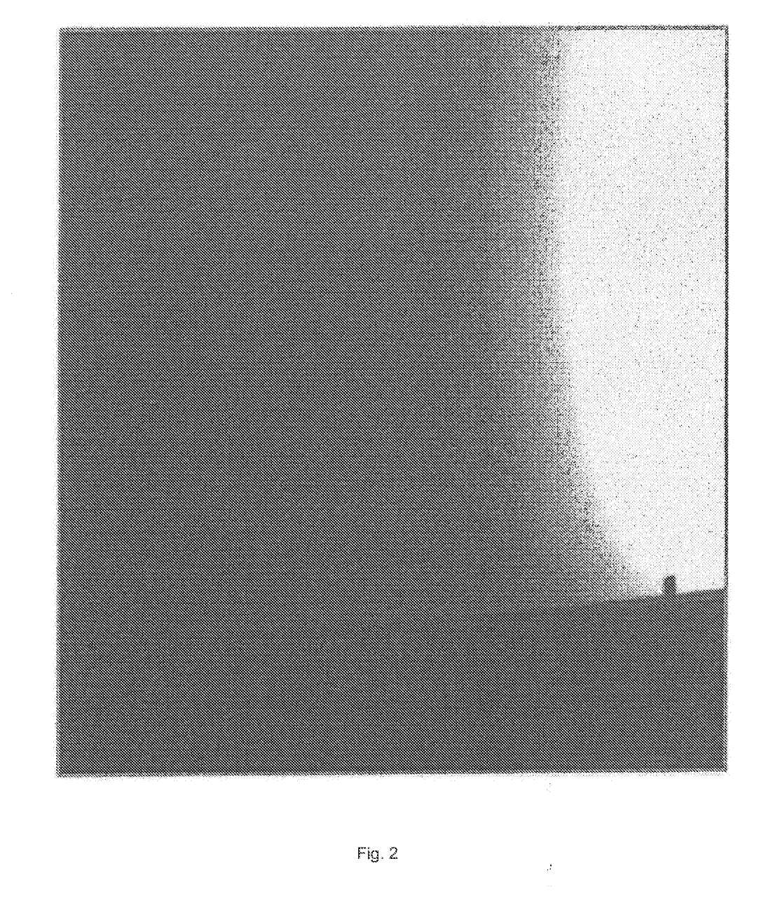

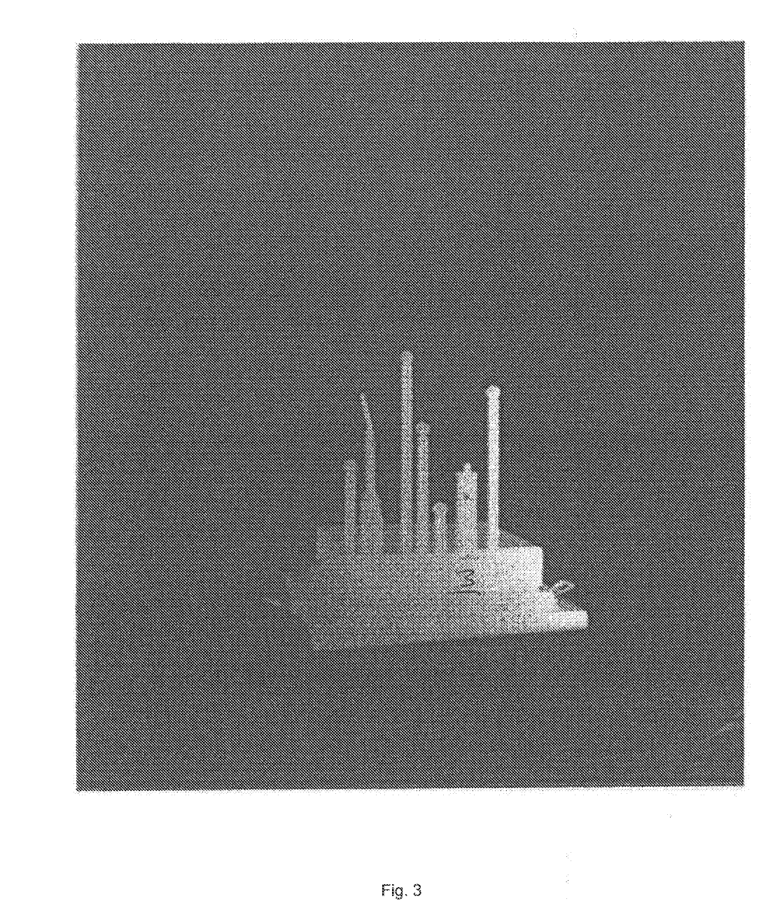

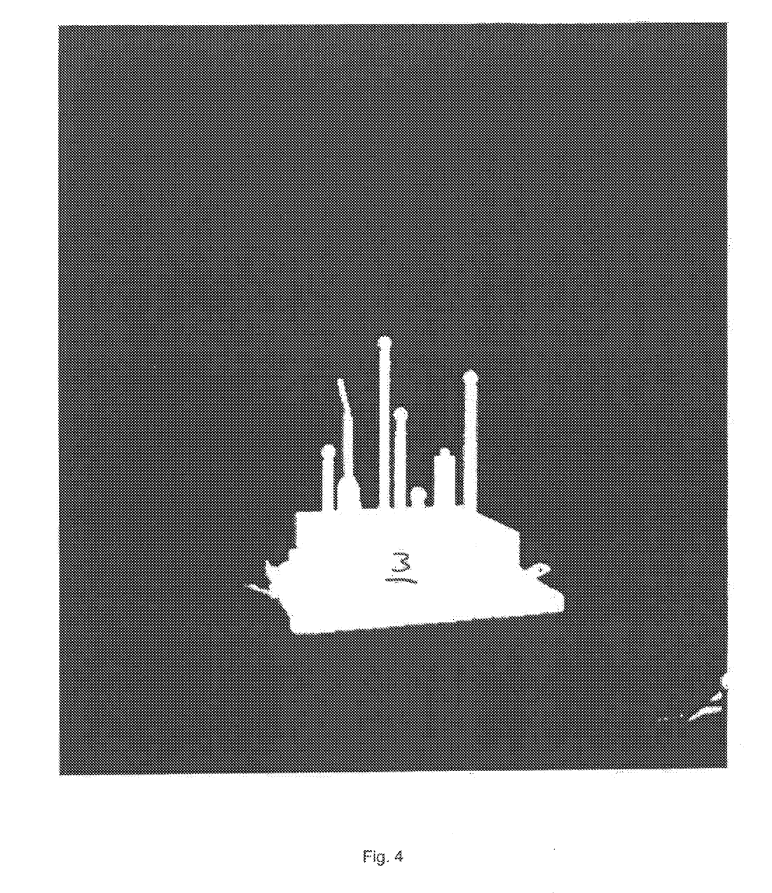

A method based on camera images of the test object is described below. Camera images from different viewing angles are used in order to determine the dimensions of a test object 3. There are different possibilities for this. Firstly, the test object 3 can be rotated about a fixed rotational axis 5. Secondly, the camera 1 can be rotated about the test object 3. The first variant is assumed below. As only the object contours are of interest, shadow images are recorded with the help of backlight. For this, the background 2 forms the only light source, which is as homogeneous as possible. The test object 3 is illuminated from behind with respect to the camera 1, whereby the object contours are silhouetted against the background 2 as a shadow boundary. An example of a shadow image is shown in FIG. 1. Using an additional background recording (FIG. 2) without test object 3 and plate, a difference image can be formed (FIG. 3), from which the test object 3 is to be extracted more simply in further steps. FIG. 4 shows a binarization of the difference image of FIG. 3.

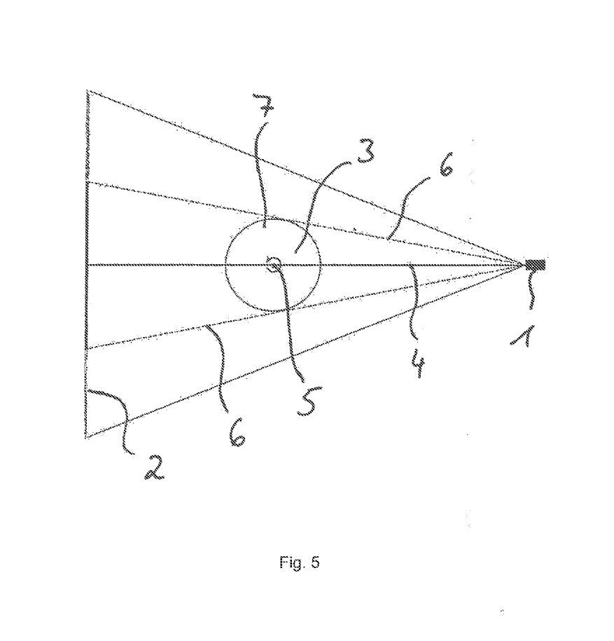

A schematic test structure is represented in FIG. 5. The homogeneously illuminated background 2 is situated on the left side. The camera 1 is positioned on the right side with the direction of view towards the illuminated background 2. The test object 3 is positioned in the area in-between, whereby it is silhouetted as a shadow against the background 2. In order to be able to record a shadow image with the camera 1, the background 2 of the test object 3 must exist as the only light source.

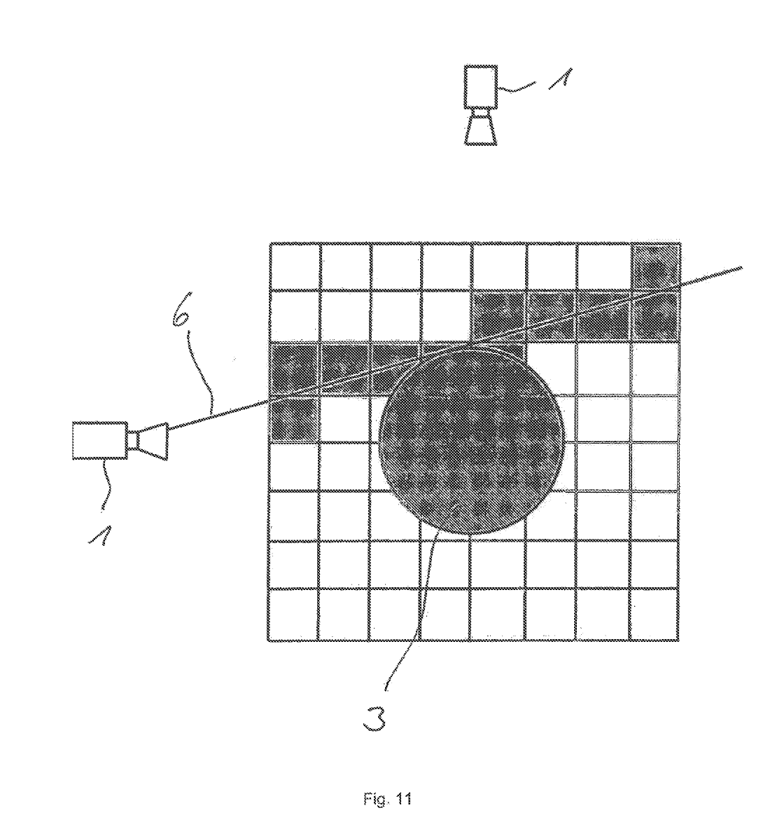

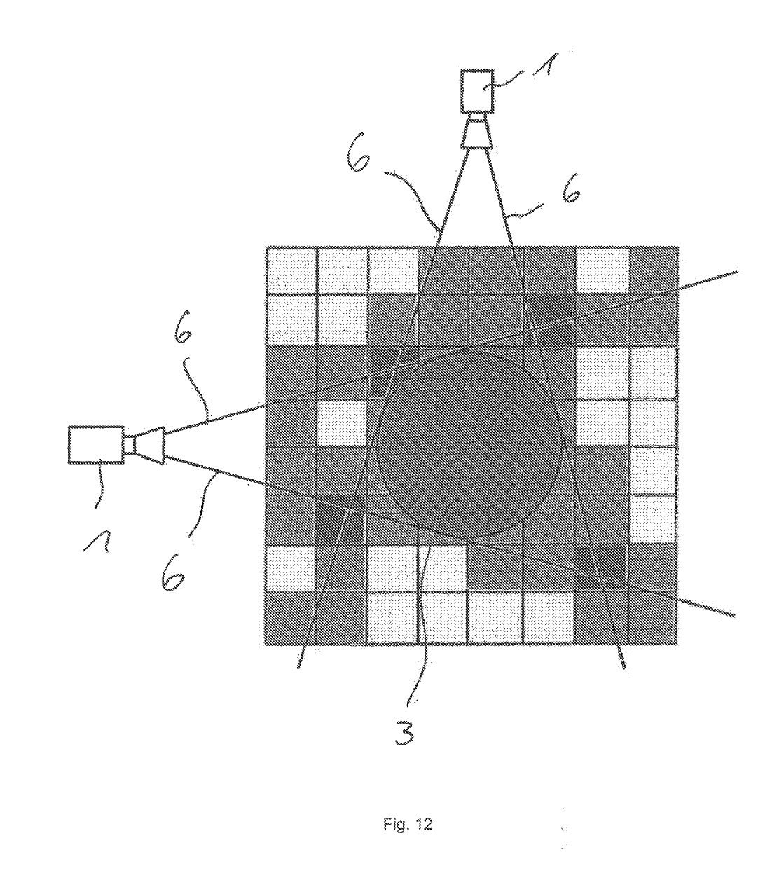

For the following approaches, firstly a specific alignment of the camera 1 with respect to the rotational axis 5 is assumed. The main axis 4 of the field of vision of the camera meets the rotational axis 5 at a right angle. The existing geometrical properties are thereby simplified; however, the vertical position of the camera 1 is limited by this condition. It is also possible to carry out a volume recognition with virtually any desired camera position. This is described in more detail below with reference to FIGS. 11 and 12.

An algorithm for volume recognition with the following inputs and outputs is now sought:
input: shadow images of the test object 3 from different viewing angles.
output: different degrees of complexity are conceivable:
   1. height h with corresponding maximum object radius rₘₐₓ in relation to the rotational axis 5,
   2. height h, angle of rotation γ with corresponding object radius r in relation to the rotational axis 5,
   3. three-dimensional volume which can be used for representation for the user.

By the object radius rₘₐₓ is meant the radius which takes in a maximum of the test object 3 starting from the rotational axis 5 in one rotation. This parameter is variable depending on height h. Furthermore, the value of the angle of rotation γ is conceivable as a variable for which, together with the height h, a corresponding object radius r exists. In the ideal case, following the volume recognition a three-dimensional object representation should moreover be available on the user's PC in order to guarantee a visual impression of the volume recognition.

For all the degrees of complexity a binarization of the test object 3 firstly takes place, as shown by way of example in FIG. 4. A value not equal to zero is found in these images at all the object positions.

If there is sufficient information about the geometry, a statement can be made about the maximum radius rₘₐₓ with respect to the height h, with reference to a direct evaluation of the binary images with little computational outlay. FIG. 5 shows a schematic representation of a corresponding test setup with a viewing angle from above. The aim is firstly to find the dark circle which is defined by rₘₐₓ and represents the hazard area 7 for a collision protection. The hazard area 7 correlates with the hazard radius 8 which is determined in the method according to the invention. This circle includes the whole test object 3 for all the rotational movements about the rotational axis 5. External items should not be situated within this area as, for at least one angular position (not necessarily all), a collision with the test object 3 would occur. The parameter FOD represents the distance between camera 1 and the rotational axis 5. The distance DOD indicates the distance between test object and a theoretical image plane behind the test object 3. The parameter s represents the size of the object shadow in the camera image. The temporary measurement r′ can be used to determine the size rₘₐₓ actually sought.

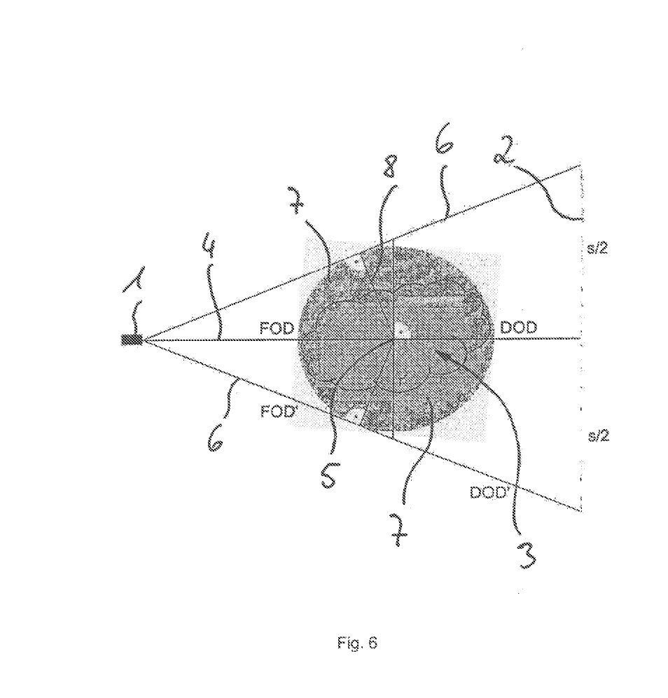

Due to the known geometry it can be assumed that the distance between test object 3 and camera 1, denoted FOD in FIG. 6, is known. For this, the test object 3 can be previously positioned at a predefined position within the field of vision of the camera. As the image plane is theoretically assumed to be on the other side of the test object 3, the distance DOD between test object 3 and this plane can be freely chosen. For the sake of simplicity FOD=DOD is selected.

Although the number of pixels within the binary image has already been given for determining the shadow size s, the pixel size for the theoretical image plane is still to be determined. It follows from the intercept theorem that

$$d = \frac{c}{f} \cdot 2 \cdot FOD$$

with the camera-specific parameters c for the sensor pixel size and f for the focal length. The assumption that, during the camera recording, the image plane or also the virtual detector is situated at exactly the same distance as the distance from camera 1 to the rotational axis 5, results in the factor 2·FOD. The real shadow size s, or s/2, then results from the pixel size and the total number of pixels.

It is also possible to determine the distance r′ with the intercept theorem

$$\frac{{r}^{′}}{\frac{s}{2}} = \frac{FOD}{FOD + DOD} ⇔ {r}^{′} = \frac{s}{4} .$$

The sought radius rₘₐₓ then results from the determination of the height of the right-angled triangle, which is spanned by FOD and r′

$${r}_{max} = \frac{FOD \cdot {r}^{′}}{\sqrt{{FOD}^{2} + {( \frac{s}{2} )}^{2}}} .$$

The individual steps of the first approach are summarized thus:
1. Go through all the binary images line by line and ascertain the edges of the object.
2. 2. For each height determine the greatest distance rₘₐₓ from the edge of the object to the rotational axis 5.
3. 3. Output of the pair of values h and rₘₐₓ.
4. 4. A cylinder in the form of the respective radii rₘₐₓ can be displayed to the user as visual feedback.
5. The named pair of values h and rₘₐₓ are an example of the above-named relevant parameters in the named table.

It is conceivable to observe not only one edge. For example, only half of all the projections can be used if the right and left edge are correspondingly observed. It is also possible to observe both edges and to use the corresponding maximum in order to minimize possible sources of error, such as for example illumination, reflection and noise.

As a second approach, it is possible not to limit the direct evaluation of the binary images introduced above for each height to the maximum radius rₘₐₓ. If the object edge is determined for each projection image at a varying angle of rotation γ, the previously circular hazard area 7 can be reduced.

For this approach, the angle of rotation γ between r′ and the respective r is of interest. This offset of the angle of rotation γ for the determined radius is denoted co and can be determined by

$$sin ω = \frac{r}{{r}^{′}} ⇔ ω = arcsin \frac{r}{{r}^{′}} .$$

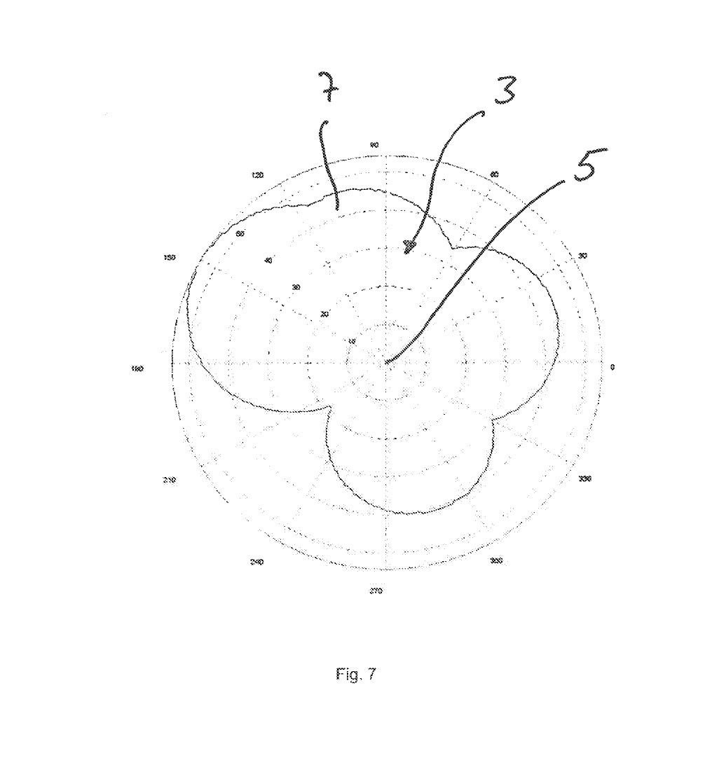

An example of this broadened approach which provides a radius r for each angle of rotation-height pair (γ, h) can be seen in FIG. 7. For orientation, the left-hand image shows a cross section through a calculated volume of the same test object 3 at the same height h. In addition, the corresponding radii starting from the rotational axis 5 are indicated. It is thereby made clear that the results of the broadened approach match the digital volume. It was possible to significantly reduce the circular hazard area 7 from the first approach.

The result of this approach is thus a more accurate indication of the hazard area 7, wherein, however, a collision protection is no longer guaranteed for any desired angle of rotation γ. The hazard area 7, as shown in FIG. 7, either applies only to the initial angular position or must correspondingly also be rotated.

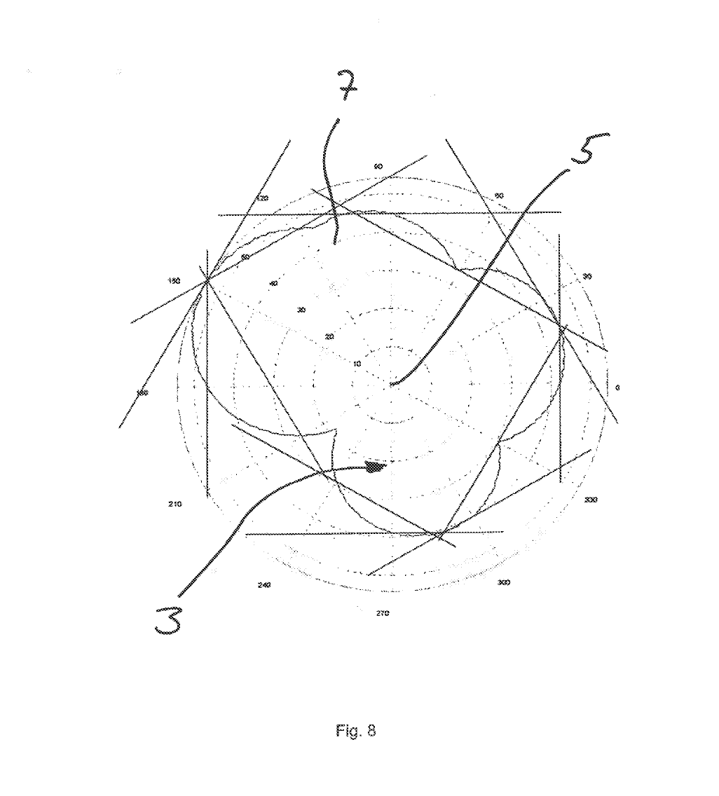

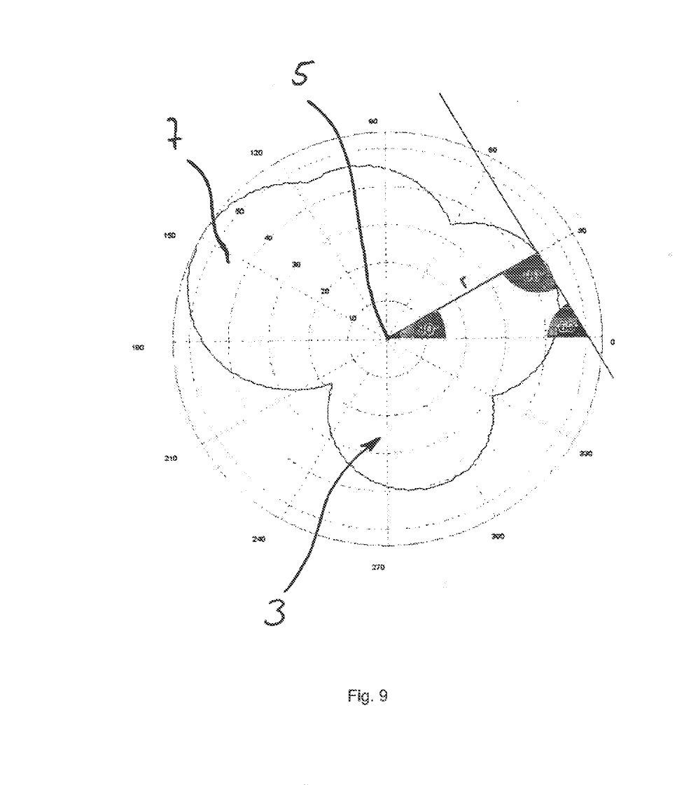

Moreover, a volumetric display as visual feedback for the user is possible on the basis of FIG. 7 in the form of a simplified volume reconstruction. This is represented schematically in FIGS. 8 and 9. Starting from the radii for each angle of rotation γ and height h any desired number of angles of rotation γ can be used for the more accurate reconstruction (in FIGS. 8 and 9 the angles of rotation γ are observed with an interval of) 30°. The orthogonals which run precisely through the radius of the current angle of rotation γ are then to be observed.

By determining the intersection points of all the straight lines, a more accurate estimation of the convex shell of the test object 3 can then be made (see FIG. 8), wherein the result of the second approach can be described as a visual sheath. The intersection points can be determined based on the information given in FIG. 9 as an example of the angle of rotation γ=30°. The estimation of the object shell becomes more accurate as the number of considered angles of rotation γ increases.

In summary, the following steps result for this second approach:
1. Go through all the binary images line by line and determine the object edges.
2. For each angle of rotation γ and each height h determine the radius r.
3. Output of r per pair (γ, h).
4. The radii r for (γ, h) can be represented to the user as a three-dimensional volume (see FIG. 7 for an exemplary horizontal layer).

The values for the radii r (γ, h) provide another example of the above-named relevant parameters in the named table. These are finer than the relevant parameters named above in the case of the first approach, as they do not give the same radius over 360°, but give it depending on the angle of rotation (the first approach, on the other hand, gives a coarsened shell end).

The third approach utilizes already-existing CT Feldkamp reconstructions (abbreviated to FDK below). For this, the shadow images are interpreted as projection images of a cone beam recording with X-radiation. All the values equal to zero then correspond to no attenuation of the X-rays. Thus no attenuating objects at all, in particular no part of the test object 3, were situated in this path. All values not equal to zero correspond to an attenuation of the radiation by the test object 3 in the beam path.

The individual steps of the third approach are summarized as follows:
1. Apply a given FDK algorithm which provides a three-dimensional volume.
2. A segmentation of the object areas of the background is carried out, which provides a binary volume.
3. From the binary volume it is possible to determine either rₘₐₓ per h or r for each pair (γ, h).
4. The unsegmented result volume can be represented to the user as visual feedback in which he can carry out the most precise navigation commands for further steps.

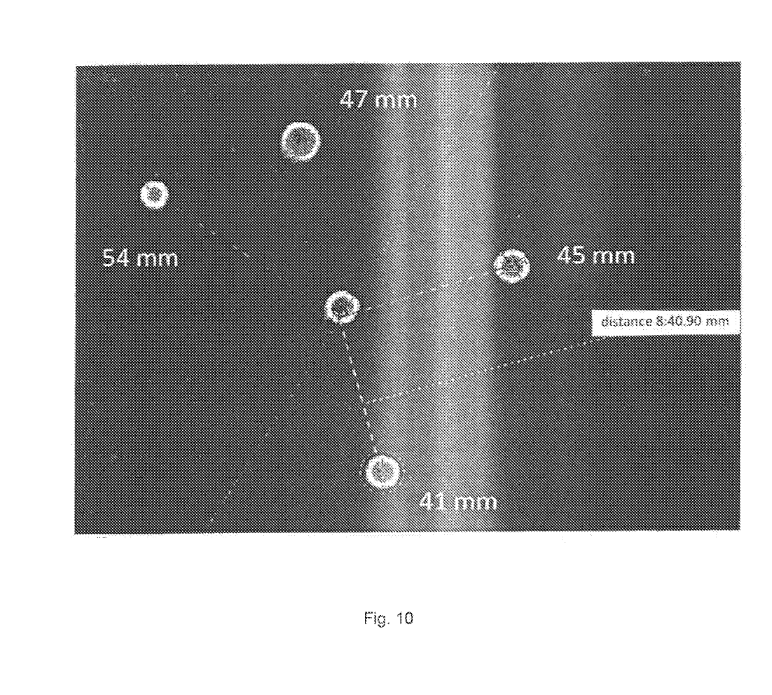

An example of this approach can be seen in FIG. 10. The imaging shows the result of such an FDK reconstruction for the test object 3 which was to be seen in FIGS. 1 to 4. Unlike the previous methods, here an accurate statement can be made about object parts within the convex sheath. However, it is to be borne in mind that this information is possible exclusively for a constant angle of rotation γ, or the hazard area 7 is also to be correspondingly rotated here.

Alternatively to the previously presented methods, the use of any desired camera position is also possible. The position of the camera 1 is determined with reference to a corresponding calibration. For a volume recognition, the beam courses of the camera 1 are then tracked at the respective viewing angle and the strike on an object edge is examined. An example of this is shown two-dimensionally in FIGS. 11 and 12, wherein an extension to the third dimension is correspondingly possible. The area in which the test object is situated is divided into pixels. Along the straight lines, the pixels are traversed and weighted. In FIG. 11 pixels weighted once from one direction of view are shown semi-dark. If several straight lines run through the same pixel, this pixel receives a higher weight, as can be seen from the dark pixels in FIG. 12. The areas with high weights then form a convex shell of the test object 3.

Instead of the described higher weighting, in the case of which background artefacts occur in the volume, a process of elimination can also be carried out for each viewing angle. The volume to be reconstructed is observed for each projection image at the corresponding angle. All the pixels that are situated outside the represented object contour are disregarded, as they cannot belong to the test object 3. The first two approaches referred to above can also be extended with this generalized camera position.

In summary, all the approaches offer the possibility of implementing an adequate volume recognition and collision protection based thereon. However, with increasing accuracy and flexibility the methods also require an increasing computational outlay. A staggered approach is therefore conceivable, starting with a simple, cylindrical volume recognition and then, depending on the user's wishes, carrying out further steps for a more accurate statement and volumetric display.

In relation to the special field of computed tomography there is in addition yet another possibility for increasing accuracy. All the methods presented are limited in terms of their resolution to the quality of the camera used. Alternatively, for a sufficiently small area, the actual X-ray image can also be used with the same methods for a volume recognition. As a rule, X-ray detectors have substantially higher resolutions than cameras 1 used as standard.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining a hazard area between a test object and an X-ray inspection system rotating in opposite directions about a rotational axis running through the test object, comprising:
arranging a radiation detector at a predetermined distance from a radiation source,
determining marginal rays which, at a predetermined angle of rotation (γ) between the test object and the arranged radiation source and radiation detector, touch an outer contour of the test object at the predetermined angle of rotation (γ),
determining a hazard radius from the outer contour to the rotational axis of the test object for the predetermined angle of rotation (γ),
repeating the determination of the marginal rays for a plurality of predetermined angles of rotation (γ) which are distributed over 360° and the determination of the hazard radius for each respective repeated determination of marginal rays, and
compiling a table with the relevant parameters of the hazard radius obtained for each of the plurality of predetermined angles of rotation (γ), of the edge of the test object.

2. The method according to claim 1, wherein a hazard radius is separately determined for each of a plurality of predetermined heights (h) along the rotational axis and the table with the relevant parameters shows the height-dependency.

3. The method according to claim 1, wherein the predetermined angles of rotation (γ) are continuously or equidistantly between 1° and 60°.

4. The method according to claim 1, wherein an X-ray tube is used as the radiation source and an X-ray detector of the X-ray inspection system is used as the radiation detector and the X-ray inspection system uses CT Feldkamp reconstruction to determine each respective hazard radius.

5. The method according to claim 1, wherein a camera sensitive to visible light is used as the radiation detector and the radiation source is a background uniformly illuminated with light that is detectable by the camera, wherein the test object is situated between the camera and the illuminated background and a shadow of the test object is recorded by the camera.

6. The method according to claim 5, wherein a main axis of a field of vision of the camera is perpendicular to the rotational axis of the test object.

7. The method according to claim 1, wherein the table with the relevant parameters is one or both of displayed visually and communicated to a control system of rotational movement of the X-ray inspection system, which then does not move towards the hazard area during the X-ray inspection of the test object.

8. The method according to claim 2, wherein a camera sensitive to visible light is used as the radiation detector and the radiation source is a background uniformly illuminated with light that is detectable by the camera, wherein the test object is situated between the camera and the illuminated background and a shadow of the test object is recorded by the camera.

9. The method according to claim 8, wherein a main axis of a field of vision of the camera is perpendicular to the rotational axis of the test object.

10. The method according to claim 3, wherein a camera sensitive to visible light is used as the radiation detector and the radiation source is a background uniformly illuminated with light that is detectable by the camera, wherein the test object is situated between the camera and the illuminated background and a shadow of the test object is recorded by the camera.

11. The method according to claim 10, wherein a main axis of a field of vision of the camera is perpendicular to the rotational axis of the test object.

12. The method according to claim 3, wherein the steps between the predetermined angles of rotation (γ) are continuously or equidistantly about 30°.
